(19) United States
(12) Patent Application Publication
(10) Pub. No.: US 2007/0271618 A1
(43) Pub. Date: Nov. 22, 2007

(54) SECURING ACCESS TO A SERVICE DATA OBJECT

(76) Inventors: CHING-YUN CHAO, Austin, TX (US); Yi-Hsiu Wei, Austin, TX (US)

Correspondence Address: INTERNATIONAL CORP (BLF), c/o BIGGERS & OHANIAN, LLP, P.O. BOX 1469, AUSTIN, TX, 78767-1469, US

(21) Appl. No.: 11/419,245

(22) Filed: May 19, 2006

(51) Int. Cl. H04L 9/32; H04L 9/00; G06K 9/00; G06F 17/30; G06F 7/04; H03M 1/68; H04K 1/00; H04N 7/16; G06F 17/00

(52) U.S. Cl. 726/27; 726/2; 713/165; 713/167; 726/1

(57) ABSTRACT

Methods, systems, and computer program products are disclosed for securing access to a service data object that include providing a service data object having an embedded security policy, and enforcing by the object the security policy of the object. Securing access to a service data object may include establishing a trust relationship with a trusted environment, transmitting the object to the trusted environment, and enforcing by the object the security policy of the object in the trusted environment. Securing access to a service data object may include exposing an interface to provide access to the object in dependence upon an authorization policy of the security policy for an authenticated user. Securing access to a service data object may include exposing attributes of the object in dependence upon an authorization policy of the security policy for an authenticated user.

### BACKGROUND OF THE INVENTION

1. Field of the Invention

The field of the invention is data processing, or, more specifically, methods, systems, and products for securing access to a service data object.

2. Description of Related Art

The Service Data Object (‘SDO’) framework is technology originally developed as a joint collaboration between IBM and BEA Systems that allows heterogeneous data to be accessed in a uniform way. The SDO framework includes an architecture and an application programming interface (‘API’). The SDO framework simplifies the Java 2 Platform, Enterprise Edition (‘J2EE’) data programming model, abstracts data in a service oriented architecture (‘SOA’), and unifies data application development.

A SDO object is a representation of structured data according to the SDO framework. In the SDO framework, SDO objects provide, not only the data of the object, but also a schema describing the structure of the data. The SDO API provides an interface for programmers to retrieve, update, and write back data unaware of the underlying data access technology. Because the SDO framework allows programmers to access and manipulate heterogeneous data in a uniform way, computer programmers do not need to be familiar with a technology-specific API in order to access and utilize the data in a service data object. Rather, computer programmers need only know one API, the SDO API, which lets programmers work with data from multiple data sources, including relational databases, entity EJB components, XML pages, Web services, the Java Connector Architecture, JavaServer Pages, and so on.

The common, self-describing data abstraction allows SDO objects to address two common data processing patterns. The first pattern involves retrieving an object from a source, updating the object, and writing the object back to the source. The second pattern involves receiving a message from a source, processing the message, updating the message, and returning the message to the original source or forwarding the message to a different source. Implementing these two patterns using serve data objects may address of a variety of scenarios that require the same data to be accessed or manipulated by more than one entity.

Consider, for example, a scenario in which a company requests a purchase from a supplier using a purchase order. One company entity, such as a person or a computer process, may submit the purchase order represented as a SDO object. The purchase order may subsequently be passed to another entity that adds tracking information, to still a third entity for approval, and to a final entity that provides the purchase order to a supplier. As the SDO object representing the purchase order is passed to each entity, each entity may access and manipulate the SDO object to perform their respective duties in requesting a purchase from the supplier.

In the example above, ideally each entity handling the purchase order should only have enough authorization to perform its respective duties on the SDO object. For example, the entity submitting the purchase order for approval should not have the authorization to manipulate the portion of the SDO object that contains data representing whether the purchase order is approved. If the SDO object remained in a data repository, security controls of the repository could easily enforce such a security policy for a SDO object. The design of the SDO architecture, however, is such that a SDO object may be processed outside and off-line from a data repository. The security controls and security policies of a repository, therefore, are not always available for securing a SDO object.

### SUMMARY OF THE INVENTION

Methods, systems, and computer program products are disclosed for securing access to a service data object that include providing a service data object having an embedded security policy, and enforcing by the object the security policy of the object. Securing access to a service data object may include establishing a trust relationship with a trusted environment, transmitting the object to the trusted environment, and enforcing by the object the security policy of the object in the trusted environment. Securing access to a service data object may include exposing an interface to provide access to the object in dependence upon an authorization policy of the security policy for an authenticated user. Securing access to a service data object may include exposing attributes of the object in dependence upon an authorization policy of the security policy for an authenticated user.

The foregoing and other objects, features and advantages of the invention will be apparent from the following more particular descriptions of exemplary embodiments of the invention as illustrated in the accompanying drawings wherein like reference numbers generally represent like parts of exemplary embodiments of the invention.

### BRIEF DESCRIPTION OF THE DRAWINGS

FIG. 1 sets forth a network diagram illustrating an exemplary system for securing access to a service data object according to exemplary embodiments of the present invention.

FIG. 2 sets forth a block diagram of automated computing machinery comprising an exemplary computer useful in securing access to a service data object according to exemplary embodiments of the present invention.

FIG. 3 sets forth a flowchart illustrating an exemplary method for securing access to a service data object according to exemplary embodiments of the present invention.

FIG. 4 sets forth a flowchart illustrating a further exemplary method for securing access to a service data object according to exemplary embodiments of the present invention.

FIG. 5 sets forth a flowchart illustrating a further exemplary method for securing access to a service data object according to exemplary embodiments of the present invention.

FIG. 6 sets forth a flowchart illustrating a further exemplary method for securing access to a service data object according to exemplary embodiments of the present invention.

FIG. 7 sets forth a block diagram illustrating a service data object useful in securing access to a service data object according to exemplary embodiments of the present invention.

FIG. 8 sets forth a block diagram illustrating a service data object useful in securing access to a service data object according to exemplary embodiments of the present invention.

### DETAILED DESCRIPTION OF EXEMPLARY EMBODIMENTS

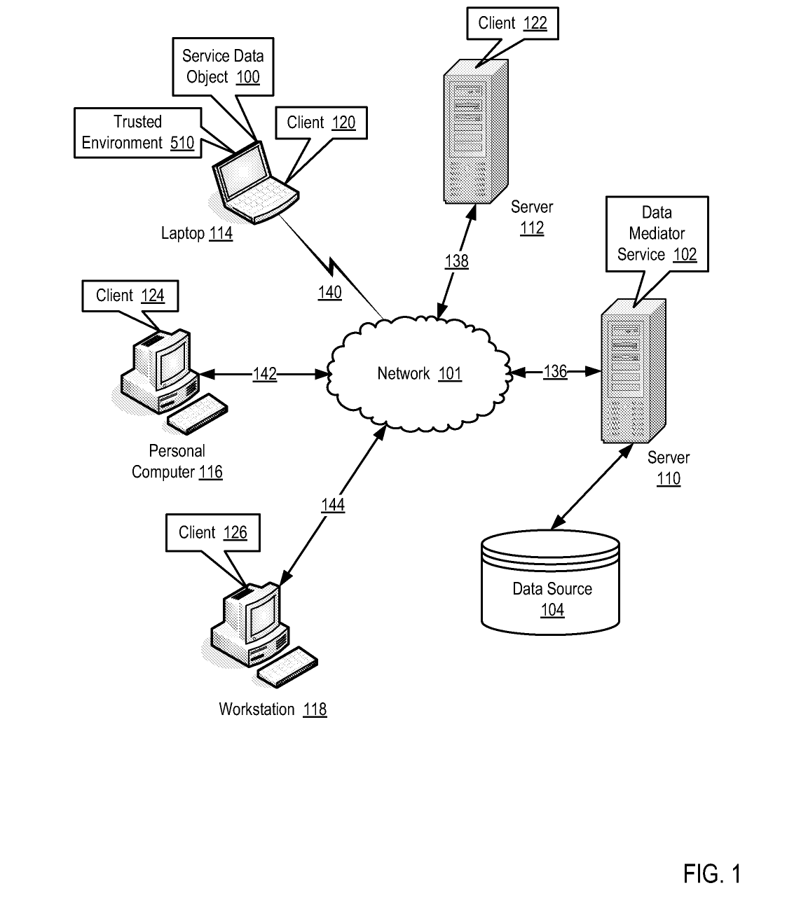

Exemplary methods, systems, and products for securing access to a service data object according to embodiments of the present invention are described with reference to the accompanying drawings, beginning with FIG. 1. FIG. 1 sets forth a network diagram illustrating an exemplary system for securing access to a service data object according to embodiments of the present invention. The system of FIG. 1 operates generally to secure access to a service data object according to embodiments of the present invention by providing a service data object having an embedded security policy, and enforcing by the object the security policy of the object.

The exemplary system of FIG. 1 includes a server (110) having installed upon it a data mediator service (102). The data mediator service (102) is a set of computer program instructions for providing a service data object having an embedded security policy from the structured data of a data source (104), transmitting a service data object to a client for data processing, receiving a service data object from a client, and updating the structured data of the data source (104) based on changes made to a service data object. The data mediator service (102) may access structured data from the data source (104) using technology specific architecture such as, for example, the Open Database Connectivity (‘ODBC’) API or the Java Database Connectivity (‘JDBC’) API.

The data mediator service (102) of FIG. 1 typically transmits and receives a data service object to and from a client as an eXtensible Markup Language (‘XML’)-based message wrapped in a Simple Object Access Protocol (‘SOAP’) envelopment using the HyperText Transfer Protocol (‘HTTP’). The data mediator service (102) of FIG. 1, however, may transmit or receive the data service object using any message format or data communication protocol as will occur to those of ordinary skill in the art. In the example of FIG. 1, the data mediator service (102) connects to the network (101) through the wireline connection (136).

The data source (104) in the exemplary system of FIG. 1 stores structured data for use by computer software applications such as, for example, the data mediator service (102). The structured data stored in data source (104) may represent a variety of information. For example, the structured data of data source (104) may represent a purchase order requesting a product from a supplier or the medical records of a patient. In the exemplary system of FIG. 1, the data source (104) is depicted as a back-end database. Such a depiction, however, is for explanation and not for limitation. In fact, the data source (104) may, for example, be implemented as a relational database, an XML-based document, or any other data source that contains structured data in its own format.

The exemplary system of FIG. 1 includes a laptop (114) having installed upon it a service data object (100). The service data object (100) is a representation of structured data that includes both the data and a schema describing the structure of the data. The service data object (100) is improved according to embodiments of the present invention to have an embedded security policy, and a set of computer program instructions for securing access to a service data object according to embodiments of the present invention. The service data object (100) operates generally for securing access to a service data object by enforcing by the object (100) the security policy of the object (100). The service data object (100) is typically a generic container and provides a common view of structured data provided by a data source. Service data objects hold their ‘data’ in properties and provide read and write access methods for those properties. Changes made to data in the service data object (100) are often stored in a change summary. Examples of service data objects that may be improved for securing access to a service data object according to embodiments of the present invention may include data objects specified in the SDO framework, the Java Data Object framework, the ActiveX data object framework, and any other data object framework as will occur to those of skill in the art.

The embedded security policy of the service data object (100) is a set of rules governing the security of the data of the service data object (100), such as, for example, the authentication and authorization of clients using the service data object (100). The embedded security policy may specify that clients listed in an authorized clients list may have access to the service data object (100). The embedded security policy may also specify that any client authenticated by a client listed in an authorized clients list may have access to the service data object (100). The embedded security policy may specify different sets of privileges for each authorized client or may specify different sets of privileges for a client depending on the type of authentication used by the client to obtain access to the service data object (100).

The exemplary system of FIG. 1 includes a number of devices (112, 114, 116, 118) having installed upon them clients (120, 122, 124, 126). A client is a set of computer program instructions for accessing and manipulating a service data object. A client typically receives a service data object from a data mediator service in response to a query for data. After modifying the data of the service data object, the client may return the data service object back to the data mediator service to have the changes applied to the original data source or forward the service data object along to another client. In the exemplary system of FIG. 1, the server (112) has installed upon it the client (122) and connects to the network (101) through a wireline connection (138). The laptop (114) has installed upon it the client (120) and connects to the network (101) through a wireless connection (140). The personal computer (116) has installed upon it the client (124) and connects to the network (101) through a wireline connection (142). The workstation (118) has installed upon it the client (126) and connects to the network (101) through a wireline connection (144).

In the example of FIG. 1, the laptop (114) also has installed upon it a trusted environment (510). A trusted environment is a computing environment that another computing environment relies upon to execute a set of computer program instructions or make a set of assertions. The trusted environment (510) of FIG. 1 may be implemented, for example, as computer hardware or software installed on the laptop (114) according to the methods and systems for establishing a trust framework based on smart key devices disclosed in Chao (U.S. Patent Publication No. 2005/0154875A1) and herein incorporated by reference. In the example of FIG. 1, the data mediator service (102) and the data source (104) may rely on trusted environment (510) to provide security services, such as, for example, cryptographic services and authentication services, for service data object (100).

In the example of FIG. 1, the data mediator service (102) has a trust relationship with the trusted environment (510). A trust relationship is the relationship between computing environments having established trusted communications. Trust relationships are often implemented using a public key cryptograph that involves the exchange of digital certificates. Digital certificates typically support public key cryptography in which each party involved in a communication or transaction has a pair of keys, called the public key and the private key. Each party's public key is typically published while the private key is kept secret. Public keys are numbers associated with a particular entity and are intended to be known to everyone who needs to have trusted interactions with that entity. Private keys are numbers that are supposed to be known only to a particular entity. That is, private keys are kept secret. In a typical asymmetric cryptographic system, a private key corresponds to exactly one public key.

Within a public key cryptography system, because all communications involve only public keys and private keys are not typically transmitted or shared, encrypted messages can be generated using only public information and can be decrypted using only a private key that is in the sole possession of the intended recipient. Encryption is the transformation of data into a form unreadable by anyone without a secret decryption key. Encryption ensures privacy by keeping the content of the information hidden from anyone for whom it is not intended, even those who can see the encrypted data. For example, when a sender encrypts a message, the public key of the receiver is used to transform the data within the original message into the contents of the encrypted message. A sender uses a public key of the intended recipient to encrypt data, and the receiver uses its private key to decrypt the encrypted message.

In addition to using a public key cryptography system for privacy, a public key cryptography system is also typically used for authentication and message integrity. Authentication is a process whereby the receiver of a digital message can be confident of the identity of the sender. Integrity provides confidence that the message has not been altered en route. Authentication and message integrity may be implemented using, for example, digital signatures. For example, a sender may sign a message with a digital signature generated using the sender's private key. Once the message is digitally signed, the message may be stored with the identity of the signer and the digital signature that proves that the message originated from the signer. The recipient may verify the message actually came from the sender by running a verification algorithm on the message along with the digital signature and the sender's public key. If the verification algorithm returns a match, then the recipient may be confident that the message arrived unaltered and that the alleged sender is, in fact, the actual sender.

A digital certificate is a digital document that vouches for the identity and key ownership of entities, such as an individual, a computer system, a specific server running on that system, etc. Digital certificates are issued by certificate authorities. A certificate authority (‘CA’) is an entity, usually a trusted third party to a transaction, that other entities trust to sign or issue certificates for other people or entities. Other entities typically trust the certificate authority to vouch for the binding between a public key and the owner of the public key because the certificate authority often has some kind of legal responsibilities for such vouching. Many commercial entities serve as certificate authorities, and these authorities are typically responsible for verifying the identity and key ownership of an entity when issuing the certificate.

When a certificate authority issues a certificate for an entity, the entity must provide a public key and some information about the entity. A software tool, such as specially equipped Web browsers, may digitally sign this information and send it to the certificate authority. As mentioned above, the certificate authority might be a commercial company that provides trusted third-party certificate authority services. The certificate authority will then typically generate the certificate and return the certificate to the requesting entity with the entity's public key embedded into the certificate. In addition to containing the public key, the certificate may contain other information such as, for example, a serial number, dates during which the certificate is valid, information about the certificate authority issuing the digital certificate. In this manner, a certificate authority typically serves as a neutral and trusted introduction service, based in part on certification authority's verification requirements, which are often openly published in their Certification Service Practices (‘CSP’).

As mentioned above, a certificate authority typically creates a new digital certificate by embedding the requesting entity's public key along with other identifying information. The certificate authority may then signs the digital certificate with the certificate authority's private key. Anyone who receives the digital certificate during a transaction or communication may then use the certificate authority's public key to verify the entity's signed public key within the certificate. The certificate authority's signature typically acts as a tamper-proof seal on the digital certificate to assure the integrity of the data in the certificate.

Other aspects of certificate processing are also standardized. Myers et al., “Internet X.509 Certificate Request Message Format,” Internet Engineering Task Force (‘IETF’) Request for Comments (‘RFC’) 2511, March 1999, specifies a format that has been recommended for use whenever a relying party is requesting a certificate from a certificate authority. Adams et al., “Internet X.509 Public Key Infrastructure Certificate Management Protocols,” IETF RFC 2511, March 1999, specifies protocols for transferring certificates.

The arrangement of servers and other devices making up the exemplary system illustrated in FIG. 1 are for explanation, not for limitation. Data processing systems useful according to various embodiments of the present invention may include additional servers, routers, other devices, and peer-to-peer architectures, not shown in FIG. 1, as will occur to those of skill in the art. Networks in such data processing systems may support many data communications protocols, including for example Transmission Control Protocol (‘TCP’), Internet Protocol (‘IP’), HTTP, Wireless Access Protocol (‘WAP’), Handheld Device Transport Protocol (‘HDTP’), and others as will occur to those of skill in the art. Various embodiments of the present invention may be implemented on a variety of hardware platforms in addition to those illustrated in FIG. 1.

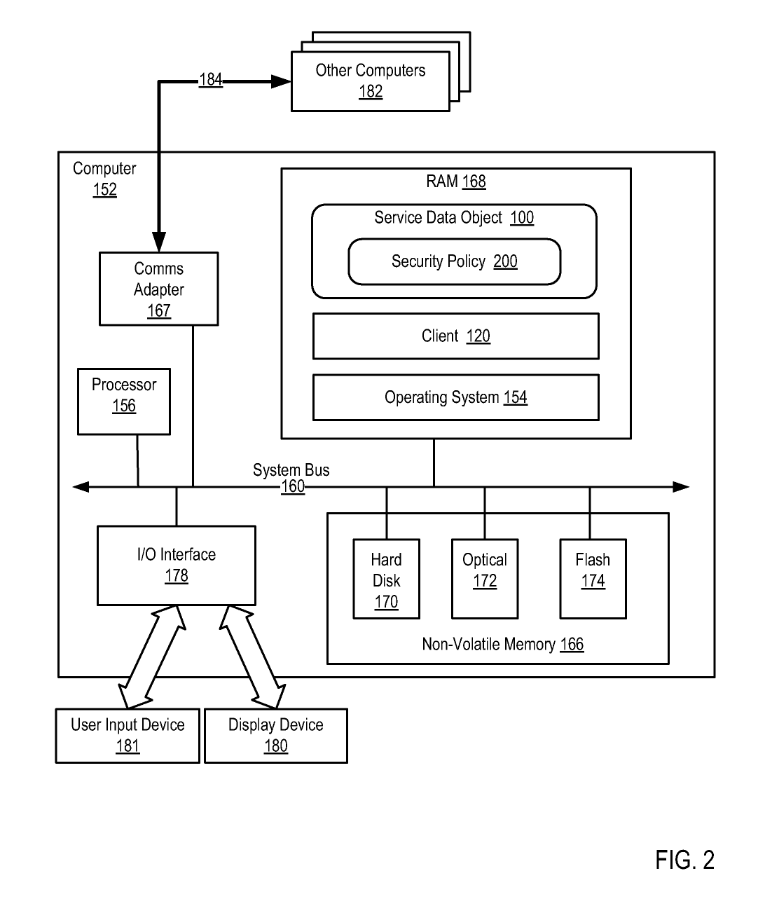

Securing access to a service data object in accordance with the present invention is generally implemented with computers, that is, with automated computing machinery. In the system of FIG. 1, for example, all the nodes, servers, and communications devices are implemented to some extent at least as computers. For further explanation, therefore, FIG. 2 sets forth a block diagram of automated computing machinery comprising an exemplary computer (152) useful in securing access to a service data object according to embodiments of the present invention. The computer (152) of FIG. 2 includes at least one computer processor (156) or ‘CPU’as well as random access memory (168) (‘RAM’) which is connected through a system bus (160) to processor (156) and to other components of the computer.

Stored in RAM (168) is a service data object (100). The service data object (100) is an improved representation of structured data having an embedded security policy (200) and a set of computer program instructions for securing access to a service data object (100) according to embodiments of the present invention. The service data object (100) operates generally for securing access to a service data object by providing a service data object having an embedded security policy and by enforcing by the object (100) the security policy (200) of the object according the embodiments of the present invention. Also stored in RAM (168) is a client (120), a set of computer program instructions for accessing and manipulating the service data object (100).

Also stored in RAM (168) is an operating system (154). Operating systems useful in computers according to embodiments of the present invention include UNIX™, Linux™, Microsoft XP™, AIX™, IBM's i5/OS™, and others as will occur to those of skill in the art. A typical operating system may be used to control the execution of threads by the processor (156) in the exemplary computer (152). The operating system (154), the service data object (100), and the client (120) in the example of FIG. 2 are shown in RAM (168), but many components of such software typically are stored in non-volatile memory (166) also.

Computer (152) of FIG. 2 includes non-volatile computer memory (166) coupled through a system bus (160) to processor (156) and to other components of the computer (152). Non-volatile computer memory (166) may be implemented as a hard disk drive (170), optical disk drive (172), electrically erasable programmable read-only memory space (so-called ‘EEPROM’or ‘Flash’ memory) (174), RAM drives (not shown), or as any other kind of computer memory as will occur to those of skill in the art.

The example computer of FIG. 2 includes one or more input/output interface adapters (178). Input/output interface adapters in computers implement user-oriented input/output through, for example, software drivers and computer hardware for controlling output to display devices (180) such as computer display screens, as well as user input from user input devices (181) such as keyboards and mice.

The exemplary computer (152) of FIG. 2 includes a communications adapter (167) for implementing data communications (184) with other computers (182). Such data communications may be carried out serially through RS-232 connections, through external buses such as the Universal Serial Bus (‘USB’), through data communications networks such as IP networks, and in other ways as will occur to those of skill in the art. Communications adapters implement the hardware level of data communications through which one computer sends data communications to another computer, directly or through a network. Examples of communications adapters useful for securing access to a service data object according to embodiments of the present invention include modems for wired dial-up communications, Ethernet (IEEE 802.3) adapters for wired network communications, and 802.11b adapters for wireless network communications.

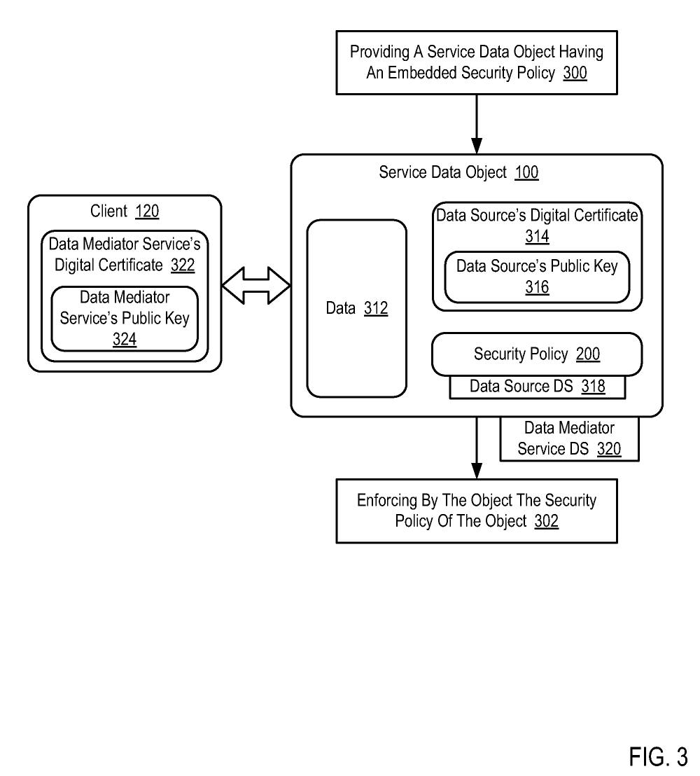

For further explanation, FIG. 3 sets forth a flowchart illustrating an exemplary method for securing access to a service data object according to embodiments of the present invention. The method of FIG. 3 includes providing (300) a service data object (100) having an embedded security policy (200). Providing (300) a service data object (100) having an embedded security policy (200) may be carried out by storing the security policy (200) inside the service data object (100). As mentioned above, the embedded security policy is a set of rules governing the security of the data (312) of the service data object (100). Storing the security policy (200) inside the service data object (100) may be carried out by a data mediator service when the service data object (100) is created. The security policy (200) of the data service object may or may not correspond to the security policy of the data source from which a data mediator service created the service data object (100). For example, a data source may provide one security policy for accessing the structured data within the data source's data repository and provide a different security policy for when the structured data is accessed and manipulated off-line using the data service object (100).

Continuing with the example above in which a company requests a purchase from a supplier using a purchase order, consider a service data object that represents a purchase order for supplies. The security policy of the purchase order may specify that only managers in the accounting department of the company are authorized to modify the service data object to approve the purchase order. In addition, the security policy may specify that only employees in the operations division of the company are authorized to submit the service data object to a supplier to fill the purchase order.

In the example of FIG. 3, the security policy (200) of the service data object (100) is stored with the data source's digital signature (‘DS’) (318). The data source's digital signature (318) provides the service data object (100) with the ability to authenticate originator of the security policy (200) and verify the integrity of the security policy. In the example of FIG. 3, the data source's digital signature (318) allows any entity using the security policy (200) to authenticate that the data source from which the service data object (100) was created actually generated the security policy (200) and that the policy (200) has not been altered. To authenticate or verify the integrity of the security policy (200), service data object (100) includes the data source's public key (316) embedded in a digital certificate (314) of the data source from which the service data object was created. In the example of FIG. 3, a data mediator service may have embedded the data source's digital certificate (314) into the service data object (100) when the data mediator service created the service data object (100). A data mediator service may obtain the data source's digital certificate (314) from the data source from which the service data object (100) was created or a directory of published digital certificates using a directory access protocol, such as, for example, the Lightweight Directory Access Protocol (‘LDAP’).

In the example of FIG. 3, the service data object (100) is signed using the digital signature (320) of the data mediator service creating the service data object (100) to prevent tampering with the service data object (100). When implement in a Java® environment, a JAR file and the Java® package containing the service data object (100) may be signed using the digital signature (320) to prevent a malicious user from tampering with the object (100). In the example of FIG. 3, the client (120) includes the data mediator service's public key (324) embedded in the data mediator service's digital certificate (322) for verifying the integrity of the service data object (100). A client may obtain the data mediator service's digital certificate (322) from the data mediator service which created the service data object (100) or a directory of published digital certificates using a directory access protocol, such as, for example, the LDAP.

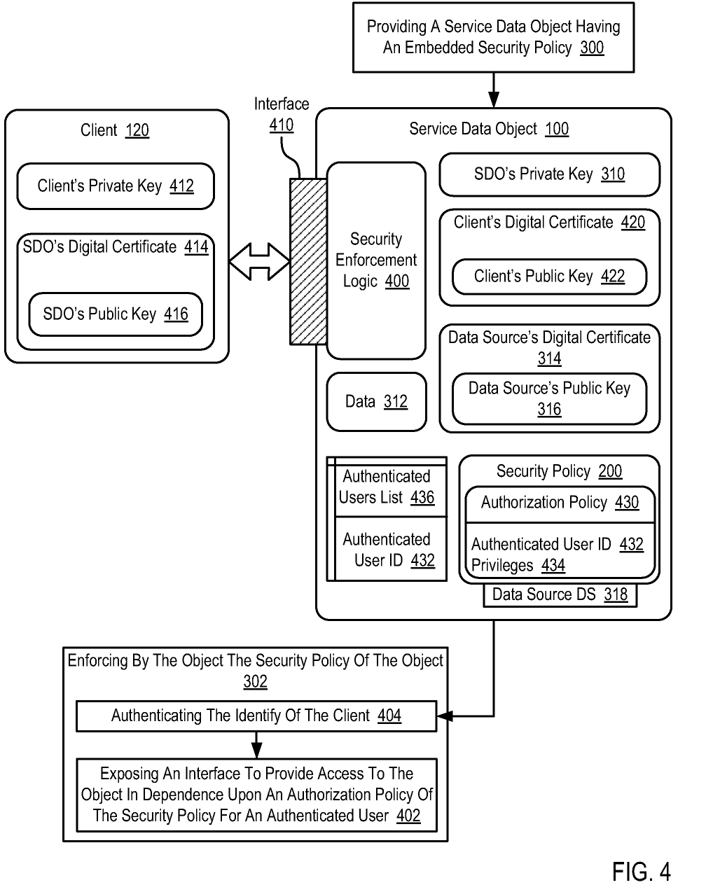

The method of FIG. 3 also includes enforcing (302) by the object the security policy of the object. Enforcing (302) by the object the security policy of the object according to the method of FIG. 3 may be carried out by exposing an interface to provide access to the object in dependence upon an authorization policy of the security policy for an authenticated user, exposing attributes of the object in dependence upon an authorization policy of the security policy for an authenticated user, or enforcing by the object the security policy of the object in the trusted environment as described below with references to FIGS. 4, 5, and 6.

As mentioned above, the enforcing by the object the security policy of the object may be carried out by exposing an interface to provide access to the object in dependence upon an authorization policy of the security policy for an authenticated user. For further explanation, therefore, FIG. 4 sets forth a flowchart illustrating a further exemplary method for securing access to a service data object according to embodiments of the present invention that includes exposing (402) an interface (410) to provide access to the object (100) in dependence upon an authorization policy (430) of the security policy (200) for an authenticated user. The method of FIG. 4 is similar to the method of FIG. 3. That is, the method of FIG. 4 is similar to the method of FIG. 3 in that the method of FIG. 4 includes providing (300) a service data object (100) having an embedded security policy (200), and enforcing (302) by the object the security policy (200) of the object (100).

The service data object (100) in the example of FIG. 4 is similar in structure to the service data object (100) in the example of FIG. 3. That is, the service data object (100) in the example of FIG. 4 is similar to the service data object (100) in the example of FIG. 3 in that the service data object (100) in the example of FIG. 4 includes data (312), a security policy (200) signed by the data source's digital signature (318), and the data source's public key (316) embedded in the data source's digital certificate (314). For additional explanation with regard to the method of FIG. 4, the service data object (100) in the example of FIG. 4 also includes the service data object's private key (310), the client's public key (422) embedded in the client's digital certificate (420), an authenticated users list (436), an interface (410), and security enforcement logic (400).

The service data object's private key (310) allows the service data object (100) to participate in a public key cryptographic system with other entities. In particular, having the service data object's private key (310) and the client's public key (422) embedded in the client's digital certificate (420) provides the service data object (100) the capability of engaging in cryptographic communication with the client (120). In the example of FIG. 4, a data mediator service may have embedded the client's digital certificate (420) into the service data object (100) when the data mediator service created the service data object (100) because the client (120) is authorized to access the data (312) in the service data object (100) according to security policy (200). The data mediator service may have obtained the client's digital certificate (420) from the data source from which the service data object (100) was created or a directory of published digital certificates using a directory access protocol, such as, for example, the LDAP. Although the only client's digital certificate embedded into the service data object (100) in the example of FIG. 4 is the digital certificate (420) of the client (120) embedded into the service data object (100), other clients may access the service data object (100) provided the other clients have been authenticated by the client (120) and the security policy (200) permits client (120) to perform authentication services for the service data object (100).

As mentioned above, the service data object (100) of FIG. 4 includes an interface (410). The interface (410) is communications boundary between the service data object (100) and other software modules, such as, for example, client (120). The interface (410) may be implemented as service data object API that exposes function for accessing the service data object. In the example of FIG. 4, the client (120) access the data (312) of the service data object (100) using interface (410).

In the example of FIG. 4, the service data object (100) also includes security enforcement logic (400). The security enforcement logic (400) is a set of computer program instructions for enforcing the security policy (200) of the object (100). The security enforcement logic (400) enforces the security policy (200) by providing authentication and authorization services for the service data object (100). In addition, the security enforcement logic (400) of the object provides other security services, such as, for example, cryptographic services, for the service data object (100).

In the method of FIG. 4, enforcing (302) by the object the security policy (200) of the object (100) includes authenticating (404) the identity of the client (120). Authenticating (404) the identity of the client (120) may be carried out by encrypting a secret phrase using the service data object's private key (310), and transmitting the encrypted phrase to the client (120). After receiving the encrypted phrase, the client decrypts the secret phrase using the service data object's public key (416) embedded in the service data object's digital certificate (414). The client may obtain the service data object's digital certificate (414) from a directory of published digital certificates using a directory access protocol, such as, for example, LDAP. After decrypting the secret phrase, the client encrypts the secret phrase using the client's private key (412) and transmits the encrypted secret phrase back to the service data object (100).

After receiving the secret phrase encrypted using the client's private key (412), authenticating the identity of the client (120) by the security enforcement logic (400) of the service data object (100) continues by decrypting the encrypted secret phrase returned by the client (120) using the client's public key (422) embedded in the client's digital certificate (420), and determining whether the decrypted secret phrase returned by the client (120) matches the original encrypted secret phrase sent by the service data object (100) to the client (120). If the decrypted secret phrase returned by the client (120) matches the original encrypted secret phrase sent by the service data object (100) to the client (120), then authenticating the identity of the client (120) continues by storing an identifier for the client in an authenticated users list (436). If the decrypted secret phrase returned by the client (120) does not match the original encrypted secret phrase sent by the service data object (100) to the client (120), then the client (120) is not authenticated and typically has little or no access to the service data object (100) depending on the security policy (200). Although the method of FIG. 4 describes the authentication process between service data object (100) and client (120) using public key and private key security data, such a description is for explanation and not for limitation. In fact, authentication methods using other security data may be useful for securing access to a service data object according to embodiments of the present invention such as, for example, a username and password, the presence of a hardware token, the presence of a software token, or any other security data as will occur to those of skill in the art.

In the method of FIG. 4, enforcing (302) by the object the security policy (200) of the object (100) may be carried out by exposing (402) an interface (410) to provide access to the object (100) in dependence upon an authorization policy (430) of the security policy (200) for an authenticated user. In the example of FIG. 4, the security policy (200) includes an authorization policy (430). The authorization policy (430) is a set of rules governing the privileges of authenticated users attempting to access the data (312) of the service data object (100). In the example of FIG. 4, the authorization policy (430) associates privileges (434) with authenticated user identifier (432). The authenticated user identifier (432) represents a user authenticated by the security enforcement logic (400) of the service data object (100) according to the security policy (200). The privileges (434) represent the set of tasks permissible for an authenticated user identified by the associated authenticated user identifier (432) to perform on the service data object (100). Different authenticated user may have difference privileges. For example, one authenticated user may be granted permission to only read from select portions of the data (312) of the service data object (100), while another authenticated user may be granted permission to read from and write to those select portions of the data (312) of the service data object (100). Although the authorization policy (430) depicted in FIG. 4 associates individual authenticated users with certain privileges, such a depiction is for explanation and not for limitation. The authorization policy (430) may, in fact, grant privileges on the basis of a user's membership in a group or on the basis of services performed by a trust environment.

In the example of FIG. 4, exposing (402) an interface (410) to provide access to the object (100) in dependence upon an authorization policy (430) of the security policy (200) for an authenticated user may be carried out by enabling functions of a service data object API and disabling functions of a service data object API in dependence upon an authorization policy (430) of the security policy (200) for an authenticated user. Enabling functions of a service data object API and disabling functions of a service data object API may be carried out by determining whether the client has privileges to access the service data object (100) through a particular function of a service data object API, and returning an error if the client does not have the privileges to access the service data object (100) according to the authorization policy (430). Consider, for example, a client attempting to access the service data object (100) for the first time. In such an example, all of the functions of a service data object API, except for the function used to authenticate a client, may return an error indicating the functions are disabled. After a client authenticates using the authentication function of the service data object API, the security enforcement logic (400) of the service data object (100) may provide the client more access to the service data object (100) according to the privileges (434) associated with the authentication user identifier (432) representing the authenticated user.

For further explanation, consider again the example above in which a service data object represents a purchase order for supplies in a company. When the security policy of the purchase order specifies that only managers in the accounting department of the company are authorized to approve the purchase order, the function of the interface of the service data object used to record an approval of the purchase order returns an authorization error unless the client invoking the approval function has authenticated that the client belongs to the group accounting managers for the company. Consider also that an additional user representing the supplier must be authorized to access the service data object when the object is transmitted to the supplier to fill the purchase order. If the security policy specifies that only employees in the operations division of the company are authorized to submit the service data object to a supplier to fill the purchase order, the function of the interface of the service data object used to add new authorization privileges to users returns an authorization error when anyone other than an employee of the operations division attempts to add authorization privileges to the service data object.

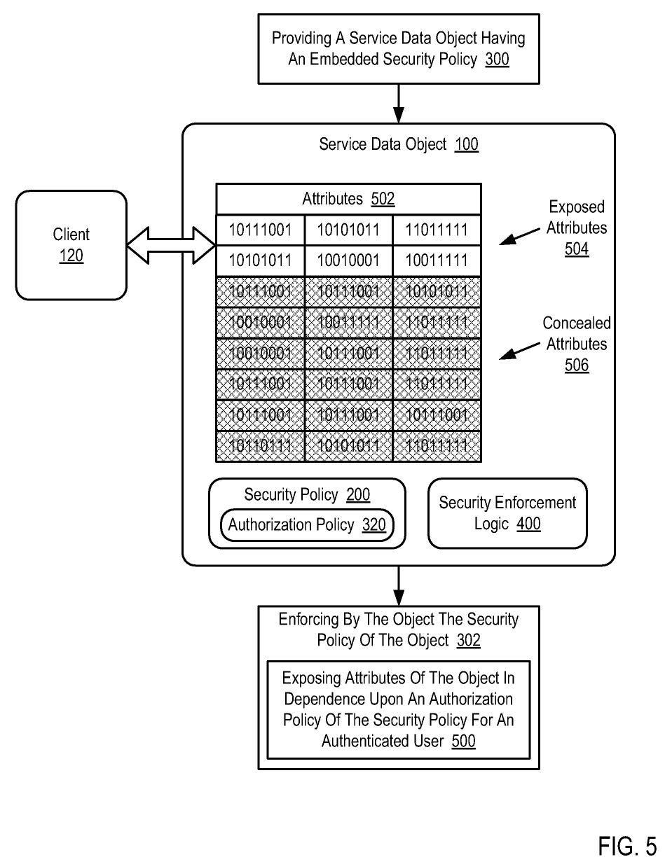

As mentioned above, the enforcing by the object the security policy of the object may be carried out by exposing attributes of the object in dependence upon an authorization policy of the security policy for an authenticated user. For further explanation, therefore, FIG. 5 sets forth a flowchart illustrating a further exemplary method for securing access to a service data object according to embodiments of the present invention that includes exposing (500) attributes of the object in dependence upon an authorization policy of the security policy for an authenticated user.

The method of FIG. 5 is similar to the method of FIG. 3. That is, the method of FIG. 5 is similar to the method of FIG. 3 in that the method of FIG. 5 includes providing (300) a service data object (100) having an embedded security policy (200), and enforcing (302) by the object the security policy (200) of the object (100). Furthermore, the service data object (100) of FIG. 5 similar to the service data object of FIG. 4. The service data object (100) of FIG. 5 similar to the service data object of FIG. 4 in that the service data object (100) of FIG. 5 includes security policy (200) having an authorization policy (320) and security enforcement logic (400).

In the example of FIG. 5, enforcing (302) by the object the security policy (200) of the object (100) includes exposing (500) attributes (502) of the object in dependence upon an authorization policy of the security policy for an authenticated user. Attributes (502) represent the data of the service data object (100). Exposing (500) attributes (502) of the object in dependence upon an authorization policy of the security policy for an authenticated user may be carried out by decrypting a portion of the service data object (100) in dependence upon an authorization policy of the security policy for an authenticated user. Decrypting a portion of the service data object (100) may be carried out by security enforcement logic (400) of the service data object (100). In the example of FIG. 5, the exposed attributes (504) represent the decrypted portions of the service data object (100) available for access by client (120). The concealed attributes (506) represent the remaining encrypted portions of the service data object (100). Exposing (500) attributes (502) of the object in dependence upon an authorization policy of the security policy for an authenticated user according to the method of FIG. 5, therefore, advantageously allows the client (120) to only access the portions of the service data object (100) for which the client (120) has authorization.

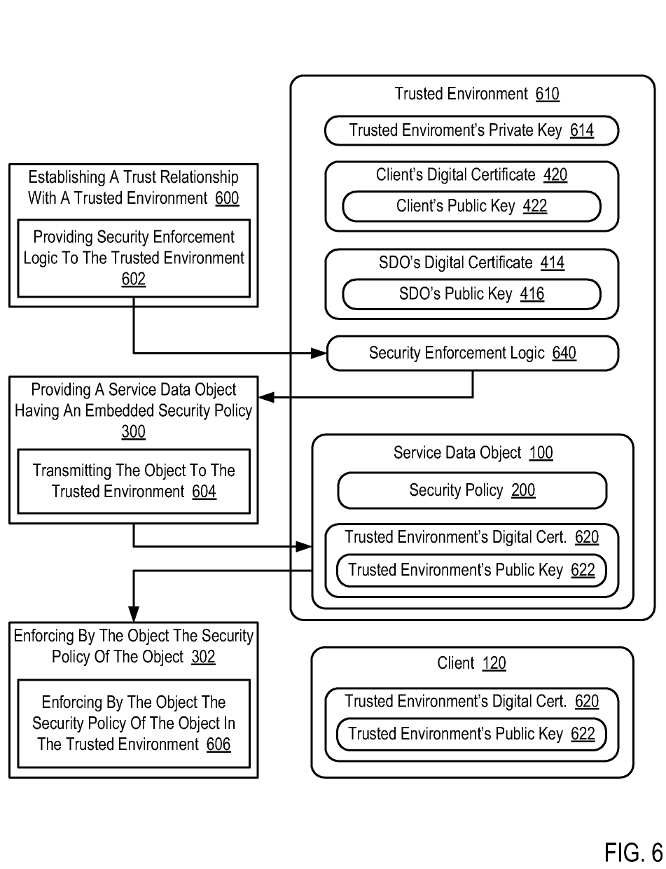

As mentioned above, the enforcing by the object the security policy of the object may be carried out by enforcing by the object the security policy of the object in a trusted environment. For further explanation, therefore, FIG. 6 sets forth a flowchart illustrating a further exemplary method for securing access to a service data object according to embodiments of the present invention that includes enforcing (606) by the object the security policy of the object in a trusted environment (610). The method of FIG. 6 is similar to the method of FIG. 3. That is, the method of FIG. 6 is similar to the method of FIG. 3 in that the method of FIG. 6 includes providing (300) a service data object having an embedded security policy, and enforcing (302) by the object the security policy of the object.

The method of FIG. 6 also includes establishing (600) a trust relationship with a trusted environment (610). The trusted environment (610) may be implemented as computer hardware or software relied upon by the service data object (100) to perform security services, such as, for example, cryptographic services and authentication services, for service data object (100). The trusted environment (610) of FIG. 6 includes the trusted environment's private key (614). The trusted environment's private key (614) provides for the trusted environment (610) the capability of engaging in public key cryptography with other entities having the corresponding asymmetric public key (622) of the trusted environment (610). The trusted environment (610) of FIG. 6 also includes the digital certificate (420) of the client (120) having the client's public key (422) and the digital certificate (414) of the service data object (100) having the service data object's public key (416). The client's digital certificate (420) and the service data object's digital certificate (414) provide for the trust environment (610) the capability of decrypting and authenticating data from the client (120) and the service data object (100). In a similar manner, the client (120) and the service data object (100) include the trusted environment's digital certificate (620) containing the trusted environment's public key (622) to provide the client (120) and the service data object (100) the capability of decrypting and authenticating data from the trusted environment (610).

Establishing (600) a trust relationship with a trusted environment according to the method of FIG. 6 may be carried out by embedding the trust environment's digital certificate (620) having the trusted environment's public key (622) into the service data object (100). Embedding the trust environment's digital certificate (620) having the trust module's public key (622) into the service data object (100) provides for the service data object (100) the capability of engaging in trusted communications with the trusted environment (610) using a public key encryption system.

In the method of FIG. 6, establishing (600) a trust relationship with a trusted environment (610) includes providing (602) security enforcement logic (640) to the trusted environment (610). Providing (602) security enforcement logic (640) to the trusted environment (610) may be carried out by transmitting the security enforcement logic (640) to the trusted environment (610) through a data communications connection such as, for example, a TCP/IP connection. Providing (602) security enforcement logic (640) to the trusted environment (610) advantageously allows the service data object (100) to off-load some of the security enforcement responsibilities to the trusted environment (610) such as, for example, authentication services. Consider, for example, the trusted environment (610), the service data object (100), and the client (120) of FIG. 6. Using public key cryptography, the trusted environment (610) may authenticate the identity of the client (120) on behalf of the service data object (100) and then assert the client's identify to the service data object (100). Because the service data object (100) relies on an authentication made by the trusted environment (610), the service data object (100) authorizes the client (120) to access the service data object (100) according to the security policy (200) for an entity authenticated by the trusted environment (610).

For further explanation, consider again the example above in which a service data object represents a purchase order for supplies in a company. The security policy of the service data object may specify that the service data object can rely on authentications made by the clients representing entities within the company such as, for example, computer machines or employees of the company, but that the service data object cannot rely on authentications made by the clients representing entities outside the company such as, for example, a computer machines or employees of a supplier.

In the example of FIG. 6, providing (300) a service data object having an embedded security policy includes transmitting (604) the object to the trusted environment. Transmitting (604) the object (100) to the trusted environment (610) may be carried out by serializing the service data object (100) into an XML-based message wrapped in a SOAP envelope. Transmitting (604) the object (100) to the trusted environment (610) may further be carried out by sending serialized service data object to the trusted environment through a data communications connection such as, for example, a TCP/IP connection using an application layer protocol such as, for example, HTTP or the Simple Mail Transfer Protocol (‘SMTP’).

In the example of FIG. 6, enforcing (302) by the object the security policy of the object includes enforcing (606) by the object the security policy of the object in the trusted environment. Enforcing (606) by the object the security policy of the object in the trusted environment may be carried out by exposing an interface to provide access to the object in dependence upon an authorization policy of the security policy for an authenticated user in a manner as discussed above with reference to FIG. 4. The service data object (100) of FIG. 6 may authorize complete access to trusted environment (610), while authorizing only partial access to the to entities authenticated by trusted environment (610). Still further, the service data object (100) may authorize even more limited access to entities authenticated by entities authenticated by trusted environment (610). The service data object (100) may not authorize any access to entities not authenticated by trusted environment (610).

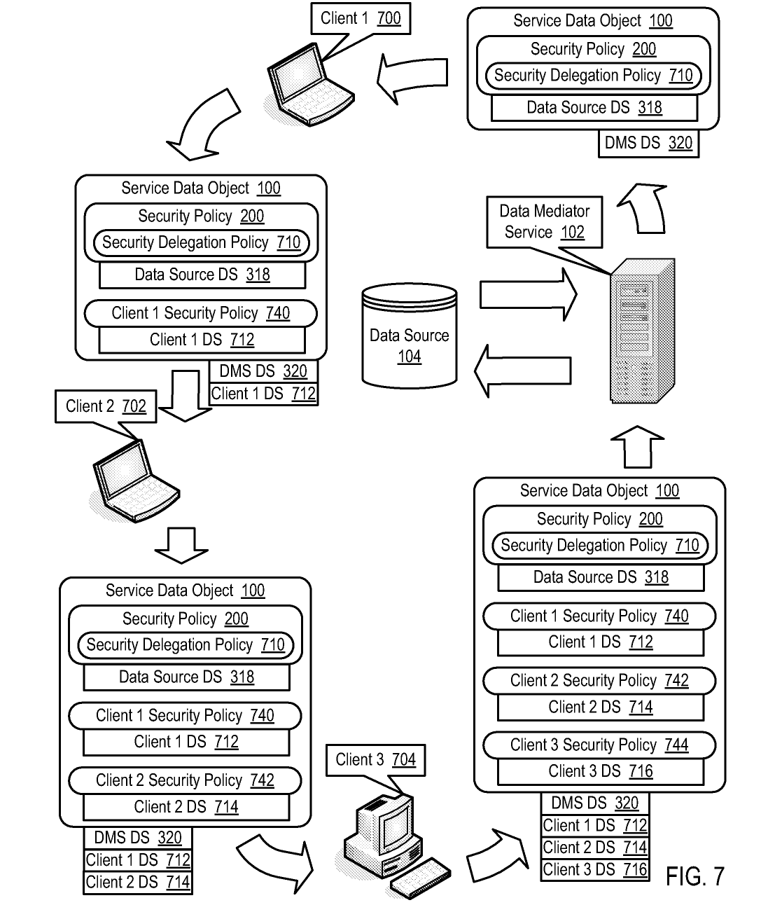

As mentioned above, securing access to a service data object according to embodiments of the present invention advantageously allows for the enforcement of a security policy for the service data object even when the service data object is outside the protection afforded by the security controls of a data repository. When a data mediator service sends a service data object to a client for data processing, for example, the service data object may be processed by more than one client before returning to the data mediator service. As the service data object travels from one client to another, each client may modify the service data object according to the original security policy embedded in the object. In addition, each client may modify the areas of the object that were modified by previous clients according to security policies embedded in the object by the previous clients. A client's ability to add its own security policy to a service data object is governed by a security delegation policy included in the original security policy of the object. For further explanation, therefore, FIG. 7 sets forth a block diagram illustrating a service data object useful in securing access to a service data object according to embodiments of the present invention that includes a security delegation policy (710).

In the example of FIG. 7, the security delegation policy (710) is a set of rules governing the delegation of security of the service data object (100) from one entity to another. Consider, for example, a service data objecting having a security policy that allows a client access to modify certain areas of the service data object (100). A security delegation policy for such a service data object may permit the client to allow other clients to have read-only access to the areas of the object modified by the first client. In other examples, the security delegation policy may allow a client to delegate all or a portion of its authority to access the service data object (100) to any entity trusted by the client. The security delegation policy, however, may only permit the client to delegate read-only access entities trusted by the client.

Returning again the example above in which a service data object represents a purchase order for supplies in a company, consider a security policy that specifies that the operations division of the company is authorized to add supplier information to the service data object such as, for example, submission data, estimated date of delivery, terms of delivery, price, and so on, and that the security policy specifies that suppliers may have read-only access to the purchase order object to determine what products to supply. In such an example, a security delegation policy of the security policy may authorize the operations division of the company to delegate its authority to add supplier information to the service data object to the suppliers themselves. In such an example, the operations division may create a new security policy for the supplier in the service data object, or modify the existing security policy, based on the security delegation policy of the object. The operations division of the company may then send the service data object to the supplier to have the supplier provide the supplier information confident that the service data object will enforce both the security policy and the delegated security policy. That is, the supplier will have read-only access to the entire purchase order object, but will only be able to have write-access to add supplier information to the purchase order object.

The example of FIG. 7 includes a ‘client 1’ (700), a ‘client 2’ (702), and a ‘client 3’ (704). Client 1 (700) queries data mediator service (102) for a set of data. In response to the query, the data mediator service (102) creates service data object (100) from the data provided by data source (104). The data mediator service (102) then transmits the data service object (100) to client 1 (700). The service data object (100) includes a security policy (200) that is signed using the digital signature (318) of the data source (104) to insure the integrity of the security policy (200). The entire service data object (100) is then signed using the data mediator service's digital signature (320) (‘DMS DS’).

In the example of FIG. 7, the client 1 (700) modifies the data of the service data object (100) according to the security policy (200) and embeds a ‘client 1 security policy’ (740) into the object (100). The ‘client 1 security policy’ (740) is a security policy that allows other clients to access areas of the service data object (100) modified by client 1 (700). The client 1 security policy (740) is signed using the digital signature (712) of the client 1 (700) to insure the integrity of the client 1 security policy (740) and to authenticate the changes made to the data of the service data object (100). The entire service data object (100) is then signed using client 1's digital signature (712) to prevent tampering with the service data object (100). In the example of FIG. 7, the client 1 (700) then transmits the service data object (100) to the client 2 (702) for further data processing.

In the example of FIG. 7, the client 2 (702) modifies the data of the service data object (100) according to the client 1 security policy (740) and the original security policy (200). Client 2 (702) then embeds a ‘client 2 security policy’ (742) into the object (100). The client 2 security policy (742) is a security policy that allows other clients to access areas of the service data object (100) modified by client 2 (702). The client 2 security policy (742) is signed using the digital signature (714) of client 2 (702) to insure the integrity of the client 2 security policy (742) and to authenticate the changes made to the data of the service data object (100). The entire service data object (100) is then signed using client 2's digital signature (714) to prevent tampering with the service data object (100). In the example of FIG. 7, the client 2 (702) then transmits the service data object (100) to the client 3 (704) for further data processing.

In the example of FIG. 7, the client 3 (704) modifies the data of the service data object (100) according to the client 2 security policy (742), the client 1 security policy (740), and the original security policy (200). Client 3 (702) then embeds a ‘client 3 security policy’ (744) into the object (100). The client 3 security policy (744) is a security policy that allows other clients to access areas of the service data object (100) modified by client 3 (704). The client 3 security policy (744) is signed using the digital signature (716) of client 3 (704) to insure the integrity of the client 3 security policy (744) and to authenticate the changes made to the data of the service data object (100). The entire service data object (100) is then signed using client 3's digital signature (716) to prevent tampering with the service data object (100). In the example of FIG. 7, the client 3 (704) then returns the service data object (100) to the data mediator service (102) for updating data source (104) with changes to the object (100). Before updating the data source (104) with the changes to the object (100), the data mediator service (102) verifies that all the changes to the service data object (100) were made according to the original security policy (200) and that the delegated security policies (740, 742, 744) were created according to the security delegation policy (710).

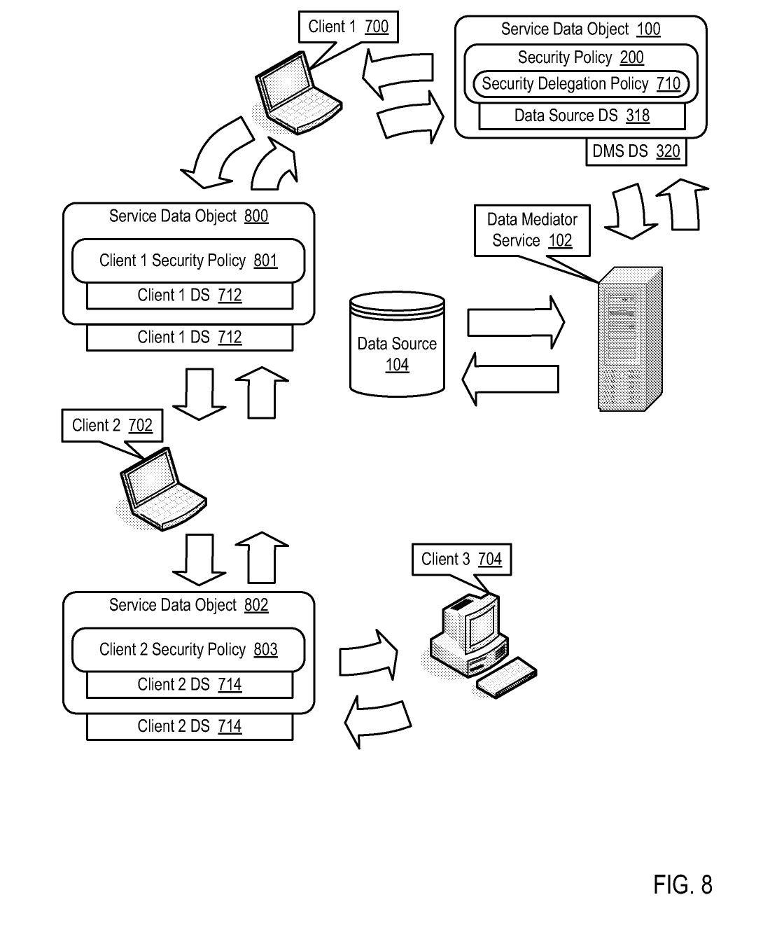

Readers will notice that, in the example of FIG. 7, each client modifies the original service data object. After modification of the object, a client may transmit the object to another client for further modification based on the authorization prescribed in the original security policy of the object and the security policies added to the object by the various clients previously modifying the object. Although a client may transmit a modified version of the service data object to other clients as described with reference to FIG. 7, a client may create an entirely new service data object to transmit other clients instead of a modified version of the original object. For further explanation, FIG. 8 sets forth a block diagram illustrating a service data object useful in securing access to a service data object according to embodiments of the present invention.

The example of FIG. 8 is similar to the example of FIG. 7. That is, the example of FIG. 8 is similar to the example of FIG. 7 in that the example of FIG. 8 includes a data source (104), a data mediator service (102), a client 1 (700), a client 2 (702), and a client 3 (704). The example of FIG. 8 differs from the example of FIG. 7 in that the service data object passed to each client (700, 702, 704) is a new service data object instead of a modified version of the original service data object (100).

Continuing with the example above in which a service data object represents a purchase order for supplies in a company, consider a security policy that specifies that the operations division of the company is authorized to add supplier information to the service data object such as, for example, submission data, estimated date of delivery, terms of delivery, price, and so on. Instead of modifying the purchase order object to allow the supplier to add the supplier information as described in the example of FIG. 7, the operations division of the company may extract the portion of the order information from the purchase order object that a supplier needs to provide the proper supplier information. The operations division may then create a new service data object that represents supplier information using the extracted data and grant the supplier access to the supplier information object using a security policy embedded in the supplier information object. Once the supplier modifies the supplier information object and returns the supplier information object to the company, the operations division may extract the supplier information from the supplier information object and incorporate the supplier information into the purchase order object.

In the example of FIG. 8, client 1 (700) queries the data mediator service (102) for a set of data. In response to the query, the data mediator service (102) creates service data object (100) from the data provided by data source (104). The data mediator service (102) then transmits the data service object (100) to client 1 (700). The service data object (100) includes a security policy (200) that is signed using the digital signature (318) of the data source (104) to insure the integrity of the security policy (200). The entire service data object (100) is then signed using the data mediator service's digital signature (320) (‘DMS DS’) to prevent tampering with the service data object (100).

In the example of FIG. 8, the client 1 (700) extracts data from the service data object (100) according to the security policy (200) of the object (100). The client 1 (700) then creates a new service data object (800) that contains the extracted data from object (100) and embeds a ‘client 1 security policy’ (801) into the object (100). The ‘client 1 security policy’ (801) is a security policy that governs the access to the service data object (800) by other clients. The client 1 security policy (801) is signed using the digital signature (712) of the client 1 (700) to insure the integrity of the client 1 security policy (740) and to authenticate the changes made to the data of the service data object (800). The entire service data object (800) is then signed using client 1's digital signature (712) to prevent tampering with the service data object (800). In the example of FIG. 8, the client 1 (700) then transmits the service data object (800) to the client 2 (702) for further data processing.

In the example of FIG. 8, the client 2 (702) extracts data from the service data object (800) according to the security policy (801) of the object (800). The client 2 (702) then creates a new service data object (802) that contains the extracted data from object (800) and embeds a ‘client 2 security policy’ (803) into the object (802). The ‘client 1 security policy’ (803) is a security policy that governs the access to the service data object (802) by other clients. The client 2 security policy (803) is signed using the digital signature (714) of the client 2 (702) to insure the integrity of the client 2 security policy (803) and to authenticate the changes made to the data of the service data object (802). The entire service data object (802) is then signed using client 2's digital signature (714) to prevent tampering with the service data object (802). In the example of FIG. 8, the client 2 (702) then transmits the service data object (802) to the client 3 (704) for further data processing.

In the example of FIG. 8, the client 3 (704) extracts data from the service data object (802) according to the security policy (803) of the object (802). When the client 3 (704) is finished accessing the service data object (802), the client 3 (704) may then transmit the service data object (802) back to the client 2 (702) for further data processing. The client 2 (702) may then modify the service data object (800) according to the changes made in service data object (802) by the client 3 (704), and may then transmit the service data object (800) back to the client 1 (700) for further data processing. The client 1 (700) may then modify the service data object (100) according to the changes made in service data object (800) by the client 2 (702), and may then transmit the service data object (100) back to the data mediator service (102) for updating the data source (104).

Exemplary embodiments of the present invention are described largely in the context of a fully functional computer system for securing access to a service data object. Readers of skill in the art will recognize, however, that the present invention also may be embodied in a computer program product disposed on signal bearing media for use with any suitable data processing system. Such signal bearing media may be transmission media or recordable media for machine-readable information, including magnetic media, optical media, or other suitable media. Examples of recordable media include magnetic disks in hard drives or diskettes, compact disks for optical drives, magnetic tape, and others as will occur to those of skill in the art. Examples of transmission media include telephone networks for voice communications and digital data communications networks such as, for example, Ethernets™ and networks that communicate with the Internet Protocol and the World Wide Web. Persons skilled in the art will immediately recognize that any computer system having suitable programming means will be capable of executing the steps of the method of the invention as embodied in a program product. Persons skilled in the art will recognize immediately that, although some of the exemplary embodiments described in this specification are oriented to software installed and executing on computer hardware, nevertheless, alternative embodiments implemented as firmware or as hardware are well within the scope of the present invention.

It will be understood from the foregoing description that modifications and changes may be made in various embodiments of the present invention without departing from its true spirit. The descriptions in this specification are for purposes of illustration only and are not to be construed in a limiting sense. The scope of the present invention is limited only by the language of the following claims.

What is claimed is:

1. A method of securing access to a service data object, the method comprising:
providing a service data object having an embedded security policy; and
enforcing by the object the security policy of the object.

2. The method of claim 1 further comprising:
establishing a trust relationship with a trusted environment;
wherein providing a service data object having an embedded security policy further comprises transmitting the object to the trusted environment; and
wherein enforcing by the object the security policy of the object further comprises enforcing by the object the security policy of the object in the trusted environment.

3. The method of claim 2 wherein establishing the trust relationship with the trusted environment further comprises providing security enforcement logic to the trusted environment.

4. The method of claim 1 wherein enforcing by the object the security policy of the object further comprises exposing an interface to provide access to the object in dependence upon an authorization policy of the security policy for an authenticated user.

5. The method of claim 1 wherein enforcing by the object the security policy of the object further comprises exposing attributes of the object in dependence upon an authorization policy of the security policy for an authenticated user.

6. The method of claim 1 wherein the service data object further comprises embedded security enforcement logic.

7. The method of claim 1 wherein the security policy further comprises a security delegation policy.

8. A system for securing access to a service data object, the system comprising a computer processor, a computer memory operatively coupled to the computer processor, the computer memory having disposed within it computer program instructions capable of:
providing a service data object having an embedded security policy; and
enforcing by the object the security policy of the object.

9. The system of claim 8 further comprising computer program instructions capable of:
establishing a trust relationship with a trusted environment;
wherein providing a service data object having an embedded security policy further comprises transmitting the object to the trusted environment; and
wherein enforcing by the object the security policy of the object further comprises enforcing by the object the security policy of the object in the trusted environment.

10. The system of claim 9 wherein establishing the trust relationship with the trusted environment further comprises providing security enforcement logic to the trusted environment.

11. The system of claim 8 wherein enforcing by the object the security policy of the object further comprises exposing an interface to provide access to the object in dependence upon an authorization policy of the security policy for an authenticated user.

12. The system of claim 8 wherein enforcing by the object the security policy of the object further comprises exposing attributes of the object in dependence upon an authorization policy of the security policy for an authenticated user.

13. The system of claim 8 wherein the service data object further comprises embedded security enforcement logic.

14. The system of claim 8 wherein the security policy further comprises a security delegation policy.

15. A computer program product for securing access to a service data object, the computer program product disposed upon a signal bearing medium, the computer program product comprising computer program instructions capable of:
providing a service data object having an embedded security policy; and
enforcing by the object the security policy of the object.

16. The computer program product of claim 15 wherein the signal bearing medium comprises a recordable medium.

17. The computer program product of claim 15 wherein the signal bearing medium comprises a transmission medium.

18. The computer program product of claim 15 further comprising computer program instructions capable of:
establishing a trust relationship with a trusted environment;
wherein providing a service data object having an embedded security policy further comprises transmitting the object to the trusted environment; and
wherein enforcing by the object the security policy of the object further comprises enforcing by the object the security policy of the object in the trusted environment.

19. The computer program product of claim 15 wherein enforcing by the object the security policy of the object further comprises exposing an interface to provide access to the object in dependence upon an authorization policy of the security policy for an authenticated user.

20. The computer program product of claim 15 wherein enforcing by the object the security policy of the object further comprises exposing attributes of the object in dependence upon an authorization policy of the security policy for an authenticated user.
